(19) United States
(12) Patent Application Publication
(10) Pub. No.: US 2010/0261014 A1
(43) Pub. Date: Oct. 14, 2010

(54) UTILIZATION OF RECYCLED CARBON FIBER

(76) Inventor: Ervin Geiger, JR., Columbia City, IN (US)

Correspondence Address: NEXSEN PRUET, LLC, P.O. BOX 10648, GREENVILLE, SC, 29603, US

(21) Appl. No.: 12/823,677

(22) Filed: Jun. 25, 2010

Related U.S. Application Data
(63) Continuation-in-part of application No. 12/684,389, filed on Jan. 8, 2010.
Application No. 12/684,389 is a division of application No. 11/592,660, filed on Nov. 3, 2006, now Pat. No. 7,678,307.
Application No. 11/592,660 is a continuation-in-part of application No. 11/106,096, filed on Apr. 14, 2005.
(60) Provisional application No. 60/562,015, filed on Apr. 14, 2004.

(51) Int. Cl. B28B 21/46; B29C 47/76

(52) U.S. Cl. 428/396; 264/101; 425/270

(57) ABSTRACT

A molding head is especially adapted for vacuum molding or forming of structures and, in particular fibrous composite structures using recycled carbon fiber, in an adjustable, controllable three dimensional orientation before, during and after molding. Such a molding head includes a mold plate with narrow slots in the mold surface thereof and wider channels in the back surface thereof, with such slots and channels intersecting one another. A control system of servomotors or other actuators permits movement and orientation of the mold head during forming, thereby creating the ability to vary the material properties based on gravity and particle or suspension grain, thickness and other now controllable properties.

### CROSS REFERENCE TO RELATED APPLICATIONS

This application is a continuation-in-part application of pending U.S. patent application Ser. No. 12/684,389 filed Jan. 8, 2010 which is a divisional application of U.S. patent application Ser. No. 11/592,660 filed Nov. 3, 2006, now U.S. Pat. No. 7,678,307, which is a continuation-in-part of pending U.S. patent application Ser. No. 11/106,096 filed Apr. 14, 2005 which, in turn, claims priority under 35 U.S.C.109(e) from expired U.S. Provisional Patent application Ser. No. 60/562,015 filed Apr. 14, 2004, all of which are incorporated herein by reference.

### BACKGROUND OF THE INVENTION

The present invention relates generally to a process for molding or forming items from pulp, slurries, or other suspensions, and products obtained thereby. More particularly the present invention relates generally to the formation of molded products from a material containing virgin or recycled carbon fibers. The vacuum mold head or mold plate in the apparatus is given the ability to be located in various orientations within the material holding tank, thereby creating the ability to control the vortex created during the molding process. By controlling the vortex the material properties can be controlled, particularly, when utilizing slurries with low solids concentrations.

The forming process of items, particularly those formed from solutions of pulps, slurries or suspensions have, up to now, never had a way to control the direction of gravity during the forming process. In the prior art, once the mold was set up, the direction of gravity was fixed relative to the mold. Gravity effects on the suspended particles in the suspensions would, during the forming process, sometimes cause non-uniform surface effects in the formed piece. What is needed in the art is a mechanism to control the orientation of the vacuum mold head relative to gravity.

The use of a vacuum mold head is well known in the art. In co-pending U.S. patent application Ser. No. 11/106,096 a device with an articulating, or gambrel, arm is described along with the ability to control the orientation of the vacuum mold head relative to gravity. This advance in the mechanism has led to further understanding in the dynamics of fiber deposition and allowed further advances in the properties which can be obtained.

Improvements in the process, and product obtained thereby, are described in commonly assigned U.S. Pat. No. 7,678,307 wherein vortex control is described.

Through diligent research it has been realized that fibers can be selectively oriented, by controlling the motion of the vacuum mold head, to increase the physical strength of the final product.

Vacuum forming techniques are characterized by the use of a mold head which has a vacuum, or suction, applied to one side of the mold head. The mold head is lowered into a slurry of fibers. As the slurry is drawn through the mold head the fibers deposit thereby forming the preform by depletion of the solids in the slurry. The solvent, typically with some concentration of fibers, passes through the filter and is either discarded or recycled. It is widely known that the slurry tends to form a vortex due to the act of drawing the slurry through a void. In extreme cases when the fiber, or solids content is very low, the vortex is approximately centrally located over the vacuum port. In many cases the impact of the vortex can be measured as variations in thickness from the center of the vortex outward. There have been many attempts to alleviate this problem by techniques such as varying the sizes of the voids, using baffles in the slurry, introducing air flow into the slurry to disrupt the local flow and other techniques. These techniques are insufficient and difficult to set up. Baffles, for example, are widely used. The location of the baffles is typically done by trial and error which requires a substantial amount of effort. If the product is changed the baffling must also be changed in ways which are not easily predicted. This leads to wasted time and effort and makes it difficult to quickly change from one product to another. Furthermore, the baffles are typically fixed relative to the tank, and within the solution, which limits changes during the fiber deposition process.

Even with the best efforts, current techniques are not sufficient and tend to be counterproductive by slowing the formation process. Depending on the shape and design of the mold head the vortex formation can be localized with a vortex for each void or it can be larger with a vortex covering larger areas of the filter. The vortex causes fibers to congregate and at least partially align approximately tangentially to the vortex within the slurry. This tangential alignment of fiber or solids may be used to increase the preform thickness in desired areas without baffling which tends to slow the formation process. As the fibers reach the filter there is, at least, localized fiber orientation or alignment. As would be realized fibers which are parallel and overlaid do not form a strong matrix and must be cross-linked, or cured, to represent a rigid structure.

Carbon fiber reinforced plastics (CFRP) have now been utilized in many products including virtually every form of transportation. The airline industry utilizes these materials as a primary structural component throughout modern airplanes and the use therein is expected to grow rapidly. The auto industry is also beginning to utilize these materials and their use is also expected to grow considerably. Even a haphazard review of the literature would illustrate the wide variety, and rapidly increasing growth, of finished products with CFRP as a critical element. Any application which requires a high ratio of strength to weight is a likely candidate for CFRP as a structural component.

The widespread use of CFRP has created a secondary issue which is now becoming critical. The process of manufacturing CFRP components necessarily creates waste. This waste is typically in the form of trimmings, unused material, scrapped products and the like. Manufacturing scrap may contain unused virgin fiber, fiber with a surface treatment, resin impregnated fibers and fibers embedded in a resin which has been partially or completely cured. The problem associated with land filling such materials is readily apparent and needs no further discussion. There has been a large effort throughout the industry to recapture the carbon fiber, and in some instances the resin, for reuse.

Another secondary issue with the widespread us of CFRP is the material incorporated in a product which has now reached the end of its useful life. These materials, often referred to in the art as end-of-life or EOL scrap, typically includes a carbon fiber embedded in a cured resin. With EOL scrap there are typically additional components such as a backing materials, coatings, oils, greases, and a wide variety of unintended materials which were either part of the original product or incorporated into the EOL scrap during the removal, storage or transport of the samples.

As set forth above there are two main sources of scrap material comprising carbon fibers. One source is generally manufacturing waste and the other source is EOL scrap. These materials have very different needs with regards to recycling due to the potential for vastly different contaminants.

The primary focus in the art has been to remove the resin, and any other materials, from the carbon fiber thereby forming a fiber which mimics a virgin fiber in form and function. The two primary techniques for reclaiming carbon fiber have relied on either pyrolysis or chemical removal of the resin and associated materials. Each technique has its advantages and disadvantages. With pyrolysis, for example, it is extremely difficult to insure complete removal of the resin without oxidizing the carbon fiber. Furthermore, if additional materials are in the sample, such as backing materials, the pyrolysis may cause char or ash to form on the surface of the carbon fiber. Regardless of the care taken during reclaiming it is highly unlikely that all of the resin will be completely removed without some level of carbon fiber degredation.

Once the carbon fibers are isolated from the resin it may be necessary to resize the fibers wherein a surface coating is applied to enhance the adhesion properties between the fiber and the eventual resin. As discussed above the surface coating may, or may not be, partially intact which complicates efforts to resize the materials. Furthermore, surface oxidation or carbonization may impede the sizing operation.

In summary, there has been a huge focus on returning used carbon fibers to a state wherein they can be used as a replacement for, or supplement to, virgin carbon fiber. The cost of such the recycling operation is high and the payback is often questionable. This has led to minimal acceptance in the field since the cost advantage may not be sufficiently high to justify material wherein the quality may, or may not be, comparable to virgin material or it may not be suitable for use as a replacement for virgin fiber.

Through diligent research the present inventors have developed a process for slurry molding applications wherein localized fiber alignment is disrupted with minimal efforts and without reliance on baffles or flow control techniques. Furthermore, the disruption provides a product which is hypothesized to have fibers oriented in a manner which approaches randomness and which are interlaced resulting in significant increases in strength relative to conventionally formed slurry molded products. A particular advantage with the process is the ability to use recycled carbon fiber which is measurably inferior relative to virgin fiber. This allows recycled carbon fiber, which may not be otherwise useful, to be incorporated into new components or parts thereby providing a way to utilize material which would otherwise be land-filled. Furthermore, since a carbon fiber can be used which is inferior to virgin fiber the cost of reclaiming the carbon fiber is greatly decreased since the purity necessary is decreased.

### SUMMARY OF THE INVENTION

The present invention includes a molding head process especially adapted for vacuum molding or forming of structures and, in particular, fibrous or particulate composite structures wherein the fibers are randomly oriented thereby providing a stronger matrix.

Yet another advantage of the present invention is that the invention can be used in conjunction with a pulp molding/die-dried process. One such procedure can be felting or molding a blank from a fibrous suspension using the mold head.

An advantage stemming from the ability to manipulate fiber or molded part orientation is that a multi-layer component can be developed in which fibers are oriented in each layer so as to promote drainage therethrough and/or to achieve a desired set of product characteristics.

Yet another advantage of the present invention is the ability to provide a multi-layered composite of differing materials accurately and under sufficient control to quickly and economically provide novel structures or conventional structures with improved properties.

Yet another advantage of the present invention is that a wide range of composite/homogeneous structures can be formed of any of various sizes, shapes, and/or compositions.

A particular advantage is the ability to utilize carbon fiber, and particularly recycled carbon fiber, in the manufacture of molded parts for use in new products.

These and other advantages, as will be realized, are provided in a molding system. The molding system has a container for holding recycled carbon fiber material to be molded. A mold head is provided on which material is be molded. At least one arm is attached to the mold head and capable of moving the mold head in three-dimensions simultaneously within the container.

Yet another embodiment is provided in a process for forming a molded part. The process includes providing a container for holding a recycled carbon fiber material to be molded. The molding head is placed into the material wherein the molding head has passages there through. A reduced pressure is applied to the molding head to draw material through the passages. The molding head is moved in three dimensions within the material and a molded part is formed on the molding head.

Yet another embodiment is provided in a molded part formed by the process of:

providing a container for holding a recycled carbon fiber material to be molded;
placing a molding head into the material wherein the molding head comprises passages there through;
applying a reduced pressure to the molding head to draw material through the passages;
moving the molded part in three dimensions within the material; and
forming the molded part on the molding head.

Yet another embodiment is provided in a process for forming a molded part. The process includes providing a container for holding a recycled carbon fiber material to be molded. The mold head is preferably equipped with vortex generators, or fences, to expand or intensify the vortex spin and may be mounted above or below the mold screen media. The molding head is placed into the material wherein the molding head has passages there through. A reduced pressure is applied to the molding head to draw material through the passages, vortex generators and/or fences. By combining the generated vortex's, and the three dimensional movement of the mold head, the material is drawn onto, or repelled from, the mold screen media used on the mold head to form a part.

Yet another embodiment is provided in a molded part formed by the process of:

providing a container for holding a material comprising recycled carbon fiber;
placing a molding head into the material wherein the molding head comprises passages therethrough;
applying a reduced pressure to the molding head to draw the material through the passages;
moving the molded part in three dimensions within the material; and
forming the molded part on the molding head.

Yet another embodiment is provided in a process for forming a molded part comprising:

forming a carbon fiber reinforced plastic;
removing recycled carbon fiber from the carbon reinforced plastic;
providing a container for holding a material comprising the recycled carbon fiber; placing a mold head into the material wherein the mold head has at least one element selected from a vortex generator and a fence to expand or intensify the vortex spin and the molding head has a mold screen thereon;
applying a reduced pressure to the molding head to draw the material through the mold head to form a vortex; and
moving the mold head in three dimensions thereby selectively altering the vortex to draw the material onto, or repel the material from, the mold screen.

Yet another embodiment is provided in a process for forming a molded part. The process comprises providing a container for holding a material to be molded wherein the material comprises recycled carbon fibers. A mold head is placed in the material wherein the mold head has at least one element selected from a vortex generator and a fence to expand or intensify vortex spin and the molding head has a mold screen thereon. A reduced pressure is applied to the molding head to draw the material through the mold head to form a vortex. The mold head is moved with three degrees of freedom thereby selectively altering the vortex to drawn the material onto, or repel the material from, the mold screen.

### BRIEF DESCRIPTION OF THE DRAWINGS

The features and advantages of this invention, and the manner of attaining them, will become more apparent and the invention will be better understood by reference to the following descriptions of the embodiments of the invention taken in conjunction with the accompanying drawings.

FIG. 1 is an diagrammatic perspective view of the molding system of one embodiment the present invention.

FIG. 2 is a diagrammatic perspective, partially cut-away, view of the mold head of FIG. 1, shown in an alternate orientation.

FIG. 3 is a diagrammatic perspective view of an alternate embodiment of the molding system for producing various size and shape molded articles showing an alternate system of controlling the three dimensional orientation of the mold head.

FIG. 4 is a diagrammatic representation of an advantage of the present invention.

FIG. 5 is a schematic diagram of a device for formation of multi-layered products.

FIG. 6 is a schematic illustration of an embodiment of the present invention.

FIGS. 7 and 8 are schematic representations of the mechanism of the present invention.

FIG. 9 is a schematic representation of an embodiment of the invention.

The exemplifications set out herein illustrate at least one preferred embodiment of the invention, in one form, and such exemplifications are not to be construed as limiting the scope of the invention in any manner.

### DETAILED DESCRIPTION OF THE INVENTION

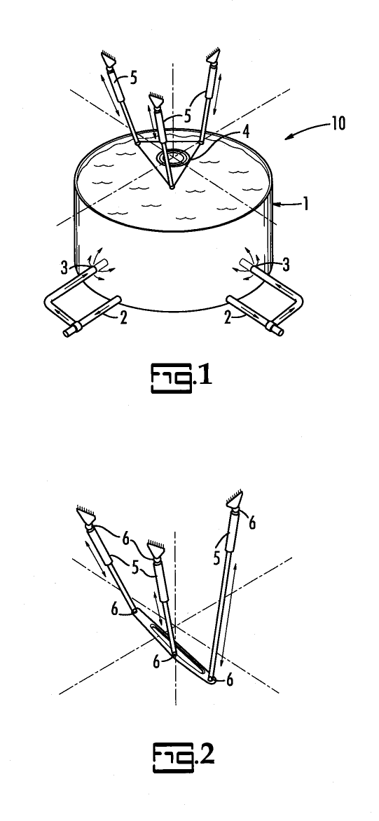

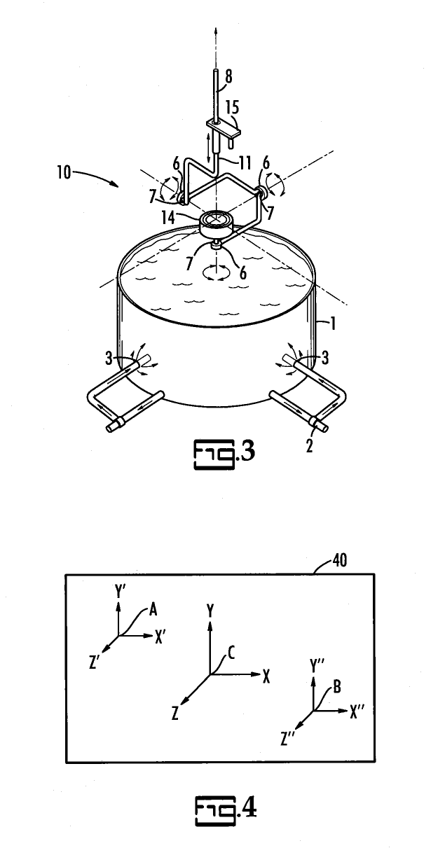

A molding system 10 of the present invention is illustrated in FIGS. 1, 2 and 3. The molding system, 10, includes a mold head 4 (FIG. 1-2) or 14 (FIG. 3). Molding heads can be manufactured from materials common in the art including, but not limited to, steel, aluminum, brass, stainless steel and composites.

Mold head 4, 14 is located in three dimensional space by at least one arm 5 (FIG. 1-2) comprised of linear servos or other manually or computer controllable actuating systems, that can fix and or relocate the three dimensional position of mold head 4, 14 during molding within a tank 1 of recycled carbon fiber in a slurry, pulp, or other suspension. Tank 1 is supplied with an agitation system 2 to continuously and substantially completely maintain the homogeneity of the recycled carbon fiber pulp, slurry or suspension within tank 1 used as the constituent material for the molded article to be formed on head 4, 14. In one embodiment the agitation system comprises a rotatable nozzle, 3, which recirculates solution within the tank by a pressurized flow. The agitation system can be a rotatable nozzle, a mixer blade or an air bubbler. Rotatable nozzles and mixer blades are preferable for easily suspended materials and an air bubbler is preferred for materials that are difficult to suspend in a slurry.

The mold head preferably has vacuum or suction ports for providing a reduced pressure thereby drawing the molding liquid through the mold head while depositing suspended fibers on the mold head. The vacuum ports may have channels or slots and may be arranged co-parallel or nearly so to each other to promote uniform fluid flow through the mold face. Yet it may prove advantageous to arrange the slots in any of a variety of patterns, for example: a star-shape, a series of concentric circles, a spiral-shape, a series of nested polygons, or potentially a non-regular pattern. The collection of vacuum ports is also referred to as a mold screen. Any of these or other patterns may be chosen to achieve a desired fluid flow for mold head 4, 14. While in most instances a uniform fluid flow will be desired, there may be instances in which a controlled non-uniformed fluid flow is desired to thereby specifically create variances in the surface of the part, or preform, being formed. No matter the pattern, it is generally preferable that slots be made as narrow as possible yet still able to sufficiently vent steam and/or drain the fluid (i.e., liquid or gas) portion of the molding suspension there through.

The molding system 10 is advantageously used as part of a molding arrangement system which further incorporates a vacuum device (8, FIG. 3). Vacuum device 8, as illustrated in FIG. 3, is connected to and may include a vacuum mold head 14, and a plurality of vacuum conduits 11, interconnected for relative articulation by rotary unions 7, allowing movement with three degrees of freedom of mold head 14 relative to gravity. Located at each rotary union 7 are servos 6 or other devices to accurately control the positioning of the conduits 11, which would necessarily then control the placement and orientation of mold head 14 in three dimensional space relative to tank 1, agitator, 3, and gravity. A servo mechanism, 15, connected to vacuum device, 8, permits the assembly to be removed from the liquid or source material of tank 1 when necessary.

It is advantageous for vacuum device, 8, to be adjustable with regards to the internal pressure and relative position.

The embodiments of molding arrangement shown in FIGS. 1-2 illustrate the variety of complex orientations, which may be utilized in the mold or forming process of the invention. As can be seen from FIGS. 1 and 2, mold head 4 can be developed for movement or controlled orientation within tank 1, thereby causing formation of thicker, shaped pieces or for molding thin fragile parts, or in all cases controlling the settling of movement of the material from suspension onto the mold forming head. By changing the effective length of arms 5, the head location may be changed before, during or after molding.

FIG. 3 illustrates a system designed for locating the mold head, 14, within the tank, 1, during the forming process, preferably, while applying vacuum or suction through mold head, 14, causing articles in suspension to build in thickness on the surface of the mold head. In the embodiment of FIG. 3, servos 6 change relative locations between vacuum conduits 11, which therefore change the location of mold head, 14, within and relative to tank 1, the suspension therein, and most importantly gravity.

A particular advantage of the present invention is described schematically with reference to FIG. 4. In FIG. 4 a mold head is illustrated at 40. Imposed on the mold head is a series of orthogonal axis with the z-axis being perpendicular to the page and the x-axis and y-axis being coplanar and in the plane of the page. The orientation of the orthogonal axis system is by convention and any axis system could be used to describe the motion. For the purposes of discussion the primary axis system has an origin at the approximate center (C) of the mold head while two secondary axis systems are at arbitrary points (A) and (B).

It has long been the practice in mold forming to have an appropriately shaped mold which is lowered into a slurry. For the purposes of the present invention this corresponds to movement along the Z-axis. In some applications, such as the manufacture of paper, the mold form is withdrawn from the solution and then translated back-and-forth within the plane of the mold to allow fibers to orient in parallel fashion.

Through diligent research it has been surprisingly realized that providing a third degree of motion within the slurry allows the fiber distribution to be more carefully controlled by altering the vortices in the slurry.

By way of explanation, again with reference to FIG. 4, the mold head, 40, can be lowered into the slurry and moved in various random directions thereby insuring that the flow dynamics on the face of the mold head vary with time during the fiber deposition process. The ability to translate the mold head in three dimensions also allows fiber buildup to be varied. By way of explanation, if the mold head is rotated approximately around the center point (C) the arbitrary point (A) can move through the slurry at a different rate than arbitrary point (B). The net effect is a fiber accumulation at arbitrary point (A) that is different from that at point (B). The difference in fiber accumulation is a function of rotation rate, solids content and solution rheology. By comparison with the prior art this type of variation would require baffling to alter the fiber deposition over arbitrary point (A) relative to the fiber deposition over arbitrary point (B). The baffling disrupts the overall flow in the tank which is detrimental to homogeneity of the slurry. By selectively controlling the movement of the mold head the homogeneity of the slurry can be maintained throughout the tank while certain regions of the mold head can be accelerated, or decelerated through the slurry as desired.

It is well within the scope of the present invention to create a molding arrangement for forming cylinders, domes, or other complex convoluted or irregular shapes, including, parts with raised portions and/or valleys/grooves. As a result, it is possible to use the molding arrangements system to create any of a variety of preform components including, but not limited to audio speakers, composite parts, multi-layer parts and the like. Even more particularly complex items formed from carbon fibers, Kevlar® fibers or other items pulled out of suspension and formed, molded or laid-up on head 4, 14 can be formed.

A particular advantage is the ability to utilize recycled carbon fiber as more specifically defined herein. The recycled carbon fiber can be the sole fiber, used in conjunction with virgin carbon fiber, or used in specific layers adjacent to layers comprising additional recycled or virgin carbon fiber or fibers of a different composition.

The molding procedure can, more particularly, be used with respect to two procedures associated with pulp molding. The first procedure is the felting of a paper/pulp blank where the mold head 4, 14 is covered with a suspension made up of wood pulp, a synthetic blend of fibers, carbon fibers, fiberglass, ceramic fibers, ceramic fiber precursors and/or other types of fibers along with water and/or another suspension fluid (e.g., another liquid or, potentially, a gas). The fibers can be straight fibers, fibrillated fibers or flocked fibers. It is also to be understood that such a suspension may also include, for example, chemicals (such as dispersants) which contribute to the suspension chemistry and/or ingredients such as binders which aid characteristics of the formed felted blank or preform.

Upon covering the mold head 4, 14 with the desired suspension, a vacuum is applied to the mold head via vacuum device, 8, or conduits, 11, in order to draw the water and/or other carrying medium from the suspension, thereby resulting in the formation of a felt-like preform or material thickness on the mold surface. The mold head 4, 14 is then removed from the suspension, and the remaining water/suspension medium is pulled from the blank via the vacuum to thereby produce a preform of a preset dryness. During the molding operation, the orientation of the mold head 4, 14 may or may not be changed in relative three dimensions within tank 1, which could lead to different material properties (e.g. thickness), among other things.

The suspension formulation used to achieve the desired product is chosen so as to get the desired suspension chemistry and rheology needed to achieve a substantially uniform distribution of the fibers both in suspension and upon precipitation thereof in such a manner so as to produce an acceptable preform in a timely fashion. Such factors as fiber material, sizing, and sizing distribution; base suspension composition and viscosity; mold shape and configuration; and vacuum characteristics can affect the generation of the product.

Alternatively, the molding system, 10, can be used to create a green-state near-net shaped product. This green-state product would typically be a ceramic/ceramic, ceramic/glass, metal/ceramic, or powdered metal or ceramic, advantageously held together by a temporary binder. As a green-state product, the product generally has enough strength to be handled but requires a further thermal processing step in order to achieve full strength and/or other (e.g., thermal, electrical, optical) capabilities. The use of a curing oven may be useful in improving the intermediate strength of the green-state product if a heat-curable resin is used as a temporary binder material in the product. In any event, the completed part, if it is a green-state near-net shaped product upon completion, will then need to be fired/sintered to produce the final usable product.

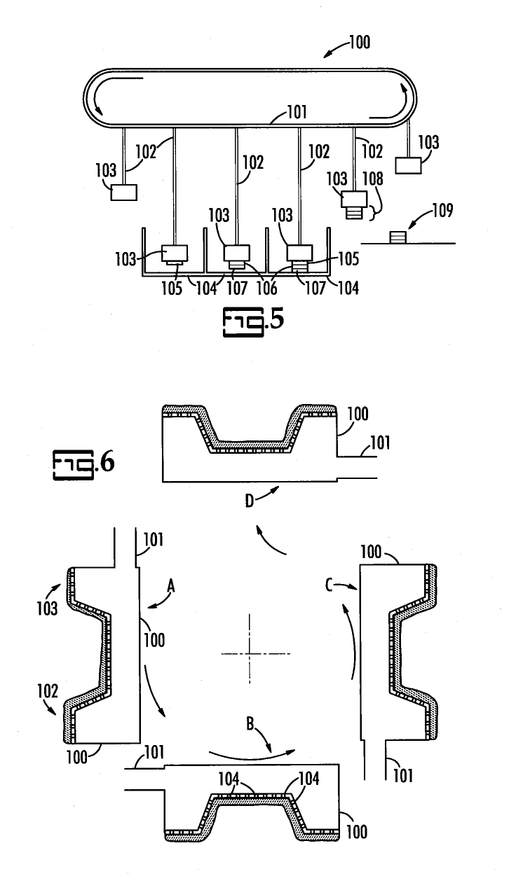

Multi-layer products can be produced using the present invention to thereby achieve the desired characteristics. In such layers, the orientation of layers and mold and part formed, composition, and/or particle/fiber size distribution, by way of example only, can be varied for each of the layers. With reference to FIG. 5, formation of a multi-layer device, generally represented at 100, is illustrated schematically. The process for forming a multi-layer device may comprise a transporter, 101, in the form of a conveyor, gantry or the like illustrated as a loop for convenience. The transporter may have associated therewith at least one transport arm, 102, wherein each transport arm comprises a mold head, 103. The transport arm, 102, sequentially lowers the mold head, 103, into at least one of a series of tanks, 104, three of which are shown for convenience without limit thereto. The mold head is moved within the tank as described elsewhere and the pressure is reduced through vacuum ports, 104, herein until a first product layer, 105, is formed thereon. Similarly, a second product layer, 106, and third product layer, 107 are formed and the mold head is removed with a multi-layer precursor, 108, adhered thereto. The multi-layer product may be further processed, such as by drying, and removed from the mold head to form a multi-layered product, 109. The mold head may then be reused. The transport arm, 102, would allow the movement of the mold head into and within the tank and provide a vacuum to the mold head as would be realized from the disclosure herein. While illustrated as a continuous process with multiple tanks and multiple transport arms, the invention can be demonstrated and is contemplated to be accomplished with a single tank which is emptied and recharged. The product layers may be the same or different.

A process for forming a preform is illustrated with reference to FIG. 6. In FIG. 6, mold head, 100, with a vacuum port, 101, is moved through a slurry in the direction of the arrows. At the first position, illustrated at A, the fiber buildup is higher at the leading edge, 102, than at the trailing edge, 103. At position B the mold head is inverted which alters the deposition rate of fibers. At position C the previously deposited material alters the apparent vacuum at the surface thereby altering the deposition of fibers. By altering the movement, and vacuum level the characteristics of the preform can be altered to accommodate the necessary properties of the product. Also, by continually moving the mold head the fibers can be intertwined to provide a preform of increased strength relative to prior art techniques.

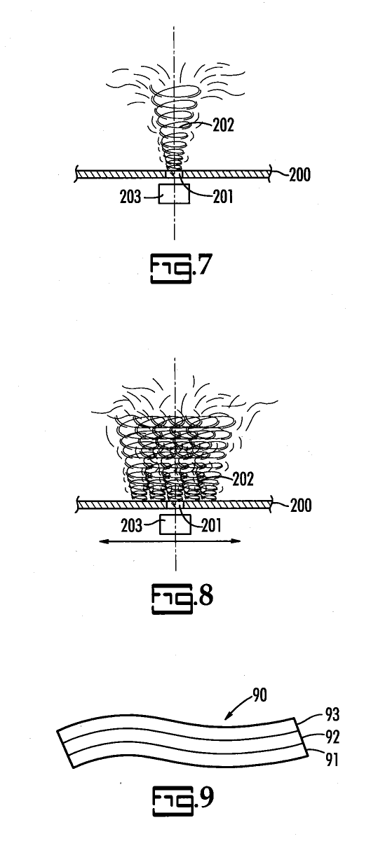

While not restricted to any theory, the proposed mechanism of the invention will be described with reference to FIGS. 7 and 8. FIG. 7 illustrates a static deposition of fibers wherein the mold head, 200, comprises a vacuum port, 201 through which a pressure reduction is applied. The mold head may also comprise a vortex generator or fence represented schematically at 203 to expand or intensify the formation of the vortex. The fibers, 202, align in tangential relationship to the vortex, as illustrated, and deposit in that manner. As realized through diligent research this forms a preform with limited strength. FIG. 8 illustrates schematically the impact of movement of the mold head. As the mold head moves, illustrated by the arrow, the vortex is realigned thereby causing the fibers to become dispersed and to be deposited in an orientation which is no longer aligned. The fibers become randomly oriented which increases the number of fibers each fiber is in contact with similar to a woven pattern. This random orientation greatly increases the strength of the preform. If the mold head is moved in a manner which is not perpendicular to the vortex, as illustrated in FIG. 6 for example, the vortex is further disrupted and fiber deposition is further randomized.

As can be seen from the description, and particularly FIGS. 7 and 8 the process includes providing a container for holding a material to be molded. The mold head is preferably equipped with vortex generators, or fences, to expand or intensify the vortex spin and may be mounted above or below the mold screen media. The molding head is placed into the material wherein the molding head has passages there through. A reduced pressure is applied to the molding head to draw material through the passages, vortex generators and/or fences. By combining the generated vortex's and the three dimensional movement of the mold head as the material is drawn onto, or repelled from, the mold with the screen media used to form a part as a near replica thereof.

An embodiment of the invention is illustrated in FIG. 9. In FIG. 9, a striated product, 90, comprising a multiplicity of layers is represented schematically as 91-93 without limit thereto. Each layer may have the same composition or each may differ from any of the others in composition, thickness and contour. For the purposes of the present invention at least one layer comprises recycled carbon fibers. As would be realized the layers are preferably removed from the mold head prior to use. It is preferable to incorporate a resin into the various layers, either during or after molding, and curing the layers by any technique known in the art. The cured layers therefore represent a carbon fiber reinforced layer and the resulting product is a carbon fiber reinforced product.

The resin, or method of curing the resin, is not limited herein. Virtually any resin and technique employed for virgin carbon fibers is suitable for use with recycled carbon fibers.

For the purposes of the present invention recycled carbon fiber is defined as a carbon fiber previously in contact with a resin or treated with a resin. In a more preferred embodiment recycled carbon fiber is defined as a carbon fiber previously incorporated in a resin which was at least partially cured. Preferably, for the purposes of the present invention the resin is at least partially removed. It is preferable that the recycled carbon fibers have no more than 10 wt % resin. More preferably the recycled carbon fibers have no more than 5 wt % resin and more preferable the recycled carbon fibers have no more than 1 wt % resin.

Recycled carbon fiber typically includes some level of transition metal contaminants such as copper, titanium, zinc and iron. For the purposes of the present invention it is preferred that the recycled carbon fiber have less than about 1 wt % of any transition metal.

The surface of a virgin carbon fiber comprises carbon primarily in the form of graphitic bonds. During the recycling process these graphitic bonds are disrupted due to oxidation. As measured by x-ray photoelectron spectroscopy (XPS) it is preferred that at least 50 mole % of the carbon bonds be graphitic bonds. Unsized recycled carbon fiber has over 33% of the carbons, as measured by XPS of the surface, as carbon oxides selected from hydroxyl carbons, carbonyl carbons and carboxylic acid carbons. In another embodiment the unsized recycled carbon fiber has at least 35% of the carbons, as measured by XPS of the surface, as carbon oxides selected from hydroxyl carbons, carbonyl carbons and carboxylic acid carbons. In yet another embodiment the unsized recycled carbon fiber has at least 36% of the carbons, as measured by XPS of the surface, as carbon oxides selected from hydroxyl carbons, carbonyl carbons and carboxylic acid carbons. More specifically, in unsized recycled carbon fiber at least 20 percent of the carbons, as measured by XPS of the surface, are hydroxyl carbons. More specifically, in unsized recycled carbon fiber at least 7 percent of the carbons, as measured by XPS of the surface, are carbonyl carbons.

A comparison of carbon composition for standard unsized recycled carbon fiber and unsized virgin carbon fiber is illustrated in Table 1 which is restated from “Characterization Of Recycled Carbon Fibers And Their Formation Of Composites Using Injection Molding”, Myles L. Conner, A thesis submitted to the Graduate Faculty of North Carolina State Univerisity In partial fulfillment of the Requirements for the degree of Master of Science, 2008 which is incorporated herein by reference and wherein the process for determining the carbon bonding on the surface is detailed. In Table 1, R1 and R2 are unsized recycled carbon fiber and V1 is unsized virgin carbon fiber.

TABLE 1

| Carbon Bonding | R1 | R2 | V1 |
|---|---|---|---|
| C—C (graphitic) | 62.31 | 63.21 | 70.65 |
| C—O (hydroxyl) | 27.51 | 25.02 | 19.38 |
| C═O (carbonyl) | 7.186 | 7.157 | 3.928 |
| O—C═O | 2.996 | 4.615 | 6.04 |
| (carboxylic acid) | | | |

After removal of the carbon fibers from the resin it is preferably to shred the fibers for use in the present application. While not limited thereto the present application it is particularly suitable for use with fibers which are at least 6.35 mm (0.25 inches) to no more than 76.2 mm (3 inches) in average length. More preferably the fibers are at least 12.7 (0.5 inches) to no more than 38.1 mm (1.5 inches) in average length.

### Example 1

A carbon fiber solution comprising 35.4 mm (1 inch) carbon fibers obtained from Toho Tenax Co. was suspended in an aqueous solution at 0.08 wt % fiber. The carbon fiber solution was placed in a tank. A 355.6×355.6 mm (14″×14″) flat text plaque mold head was lowered into the tank until completely submerged in the carbon fiber solution and rotated less than 45° about its central axis into the flow stream over a time span of about 18-30 seconds with a vacuum applied to the mold head. The mold head was removed from the solution, the deposited carbon fibers were dried and observed. The carbon fiber built up on the trailing edge of the mold head was about twice as thick as the carbon fiber built up on the leading edge. The fibers were approximately aligned and the deposit was easily peeled in sheet form.

### Example 2

A carbon fiber solution was prepared as in EXAMPLE 1. The mold head described in EXAMPLE 1 was lowered into the tank and completely submerged, as in Example 1 Unlike EXAMPLE 1 the mold head was rotated and oscillated until the amount of fiber deposited was approximately equal to that of EXAMPLE 1. The mold head was removed from the solution, the deposited carbon fibers were dried and observed. The carbon fiber build up was more evenly distributed and more randomly oriented and the fibers were difficult to separate relative to EXAMPLE 1.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A molding system comprising:
a container for holding a material comprising recycled carbon fiber;
a mold head on which said material is be molded;
at least one arm attached to said mold head and capable of moving said mold head in three-dimensions within said container.

2. The molding system of claim 1 wherein said material is a slurry.

3. The molding system of claim 1 wherein said material comprises a solvent.

4. The molding system of claim 1 wherein said recycled carbon fiber comprises no more than 10 wt % resin.

5. The molding system of claim 4 wherein said recycled carbon fiber comprises no more than 5 wt % resin.

6. The molding system of claim 5 wherein said recycled carbon fiber comprises no more than 1 wt % resin.

7. The molding system of claim 1 wherein said recycled carbon fiber has least 50% of surface carbons are in graphitic bonds.

8. The molding system of claim 1 wherein said recycled carbon fiber has least 33% of surface carbons in carbon oxide bonds.

9. The molding system of claim 8 wherein said recycled carbon fiber has least 35% of surface carbons in carbon oxide bonds.

10. The molding system of claim 9 wherein said recycled carbon fiber has least 36% of surface carbons in carbon oxide bonds.

11. The molding system of claim 8 wherein said surface carbons in carbon oxide bonds are selected from hydroxyl carbons, carbonyl carbons and carboxylic acid carbons.

12. The molding system of claim 11 wherein at least 20% of said surface carbons in carbon oxide bonds are hydroxyl carbons.

13. The molding system of claim 11a wherein at least 7% of said surface carbons in carbon oxide bonds are carbonyl carbons.

14. The molding system of claim 1 wherein said recycled carbon fiber has an average length of at least 6.3 mm to no more than 76.2 mm.

15. The molding system of claim 14 wherein said recycled carbon fiber has an average length of at least 12.7 mm to no more than 38.1 mm.

16. A process for forming a molded part comprising:
providing a container for holding a material comprising recycled carbon fiber;
placing a molding head into said material wherein said molding head comprises passages therethrough; and
applying a reduced pressure to said molding head to draw material through said passages.

17. The process of forming a molded part of claim 16 further comprising moving said molding head in three dimensions within said material; and
forming said molded part on said molding head by depletion of said material.

18. The process of forming a molded part of claim 16 further comprising a pressure reduction device associated with said mold head capable of drawing material through said mold head.

19. The process of forming a molded part of claim 18 in which said pressure reduction device includes at least one rotary union, such that vacuum pressure may be applied to said mold head while said mold head is in different positions within said container.

20. The process of forming a molded part of claim 19 in which said pressure reduction device varies the vacuum pressure applied to said mold head during said process.

21. The process of forming a molded part of claim 16 further comprising an arm comprising servos for moving said mold head.

22. The process of forming a molded part of claim 21 in which said arm comprises linear servos for moving said mold head within said container.

23. The process of forming a molded part of claim 16 wherein said material is drawn through said mold head forming a vortex perpendicular to a portion of said mold head and said portion of said mold head is moved in a direction which is not perpendicular to said vortex.

24. The process of forming a molded part of claim 16 wherein said recycled carbon fiber comprises no more than 10 wt % resin.

25. The process of forming a molded part of claim 24 wherein said recycled carbon fiber comprises no more than 5 wt % resin.

26. The process of forming a molded part of claim 25 wherein said recycled carbon fiber comprises no more than 1 wt % resin.

27. The process of forming a molded part of claim 16 wherein said recycled carbon fiber has least 50% of surface carbons in graphitic bonds.

28. The process of forming a molded part of claim 16 wherein said recycled carbon fiber has least 33% of surface carbons in carbon oxide bonds.

29. The process of forming a molded part of claim 9 wherein said recycled carbon fiber has least 35% of surface carbons in carbon oxide bonds.

30. The process of forming a molded part of claim 10 wherein said recycled carbon fiber has least 36% of surface carbons in carbon oxide bonds.

31. The process of forming a molded part of claim 28 wherein said surface carbons in carbon oxide bonds are selected from hydroxyl carbons, carbonyl carbons and carboxylic acid carbons.

32. The process of forming a molded part of claim 31 wherein at least 20% of said surface carbons in carbon oxide bonds are hydroxyl carbons.

33. The process of forming a molded part of claim 31 wherein at least 7% of said surface carbons in carbon oxide bonds are carbonyl carbons.

34. The process of forming a molded part of claim 1 wherein said recycled carbon fiber has an average length of at least 6.3 mm to no more than 76.2 mm.

35. The process of forming a molded part of claim 1 wherein said recycled carbon fiber has an average length of at least 12.7 mm to no more than 38.1 mm.

36. A molded part formed by the process of:
providing a container for holding a material comprising recycled carbon fiber;
placing a molding head into said material wherein said molding head comprises passages therethrough;
applying a reduced pressure to said molding head to draw said material through said passages;
moving said molded part in three dimensions within said material; and
forming said molded part on said molding head.

37. The molded part of claim 36 wherein said recycled carbon fiber comprises no more than 10 wt % resin.

38. The molded part of claim 36 wherein said recycled carbon fiber has least 50% of surface carbons in graphitic bonds.

39. The molded part of claim 36 wherein said recycled carbon fiber has least 33% of surface carbons in carbon oxide bonds.

40. The molded part of claim 39 wherein said recycled carbon fiber has least 35% of surface carbons in carbon oxide bonds.

41. The molded part of claim 40 wherein said recycled carbon fiber has least 36% of surface carbons in carbon oxide bonds.

42. The molded part of claim 39 wherein said surface carbons in carbon oxide bonds are selected from hydroxyl carbons, carbonyl carbons and carboxylic acid carbons.

43. The molded part of claim 42 wherein at least 20% of said surface carbons in carbon oxide bonds are hydroxyl carbons.

44. The molded part of claim 42 wherein at least 7% of said surface carbons in carbon oxide bonds are carbonyl carbons.

45. The molded part of claim 36 wherein said recycled carbon fiber has an average length of at least 6.3 mm to no more than 76.2 mm.

46. A process for forming a molded part comprising:
forming a carbon fiber reinforced plastic;
removing recycled carbon fiber from said carbon reinforced plastic;
providing a container for holding a material comprising said recycled carbon fiber;
placing a mold head into said material wherein said mold head has at least one element selected from a vortex generator and a fence to expand or intensify the vortex spin and said molding head has a mold screen thereon;
applying a reduced pressure to said molding head to draw said material through said mold head to form a vortex; and
moving said mold head in three dimensions thereby selectively altering said vortex to drawn said material onto, or repel said material from, said mold screen.

47. The process for forming a molded part of claim 46 further comprising:
molding said carbon fiber reinforced plastic into a part.

48. The process for forming a molded part of claim 27 wherein said molding occurs prior to said removing.

49. The process for forming a molded part of claim 46 wherein said recycled carbon fiber comprises no more than 10 wt % resin.

50. The process for forming a molded part of claim 46 wherein said recycled carbon fiber has least 50% of surface carbons in graphitic bonds.

51. The process for forming a molded part of claim 46 wherein said recycled carbon fiber has least 33% of surface carbons in carbon oxide bonds.

52. The process for forming a molded part of claim 51 wherein said surface carbons in carbon oxide bonds are selected from hydroxyl carbons, carbonyl carbons and carboxylic acid carbons.

53. The process for forming a molded part of claim 52 wherein at least 20% of said surface carbons in carbon oxide bonds are hydroxyl carbons.

54. The process for forming a molded part of claim 52 wherein at least 7% of said surface carbons in carbon oxide bonds are carbonyl carbons.

55. A process for forming a molded part comprising: providing a container for holding a material to be molded wherein said material comprises recycled carbon fibers; placing a mold head into said material wherein said mold head has at least one element selected from a vortex generator and a fence to expand or intensify vortex spin and said molding head has a mold screen thereon; applying a reduced pressure to said molding head to draw said material through said mold head to form a vortex; and moving said mold head with three degrees of freedom thereby selectively altering said vortex to drawn said material onto, or repel said material from, said mold screen.
